(19) United States
(12) Patent Application Publication
(10) Pub. No.: US 2021/0102511 A1
(43) Pub. Date: Apr. 8, 2021

(54) Internal-Combustion Engine Piston and Method for Controlling Cooling of Internal-Combustion Engine Piston

(71) Applicant: Hitachi Automotive Systems, Ltd., Hitachinaka-shi, Ibaraki (JP)

(72) Inventors: Yoshihiro SUKEGAWA, Tokyo (JP); Norikazu TAKAHASHI, Hitachinaka-shi (JP)

(21) Appl. No.: 16/606,992

(22) PCT Filed: Apr. 12, 2018
(86) PCT No.: PCT/JP2018/015347

§ 371 Date: Oct. 21, 2019

(30) Foreign Application Priority Data
Apr. 25, 2017 (JP) 2017-085920

(51) Int. Cl. F02F 3/22; F02F 3/10; F01P 3/10; F01P 7/16; F16J 1/01; F16J 1/09; C22F 1/04; C22F 1/00

(52) U.S. Cl. CPC F02F 3/22; F02F 3/10; F01P 3/10; C22F 1/002; F16J 1/01; F16J 1/09; C22F 1/04; F01P 7/16

(57) ABSTRACT

It is an object of the present invention to provide a novel internal-combustion engine piston which makes it possible to achieve both an improvement in thermal efficiency and a reduction in exhaust harmful components, and to suppress the occurrence of abnormal combustion such as knocking and pre-ignition. A cooling passage is formed in a piston, and on a top face of the piston are provided a first heat shielding layer composed of a material having a lower thermal conductivity and volumetric specific heat than those of a piston base material, and a second heat shielding layer composed of a material having a lower thermal conductivity and volumetric specific heat than those of the first heat shielding layer, wherein a first distance between the first heat shielding layer and the cooling passage is set to be less than a second distance between the second heat shielding layer and the cooling passage. A cooling loss can be reduced by the second heat shielding layer, and the vaporization of fuel adhering to the piston can be promoted by the first heat shielding layer to reduce exhaust gas harmful components. Since the first distance is less than the second distance, the temperature of the first heat shielding layer does not rise excessively, whereby the occurrence of knocking and pre-ignition can be suppressed.

### TECHNICAL FIELD

The present invention relates to a piston forming a combustion chamber of an internal-combustion engine, and more particularly to an internal-combustion engine piston including a heat insulating layer formed on a combustion chamber-side top face of a piston body and a method for controlling cooling of the piston.

### BACKGROUND ART

In an internal-combustion engine such as a gasoline engine, a part of heat generated by combustion is discharged from the inside of a combustion chamber to the outside through a piston or a cylinder wall and the like to cause a cooling loss. In order to improve the thermal efficiency of the internal-combustion engine, it is necessary to reduce the cooling loss. Therefore, the following technique, a so-called temperature swing heat shield method has been known. A layer having a low thermal conductivity and a low heat capacity is formed on a combustion chamber-side top face of a piston body occupying a relatively large area in a wall surface of a combustion chamber, whereby the surface temperature of the top face of the piston body is caused to follow an in-cylinder combustion gas temperature with a small time delay to reduce a heat flux on the surface of the piston.

In the following description, the top face is mentioned, including a surface forming the combustion chamber, which is formed on the top face of the piston body. Therefore, the top face of the piston body means the combustion chamber-side surface of the piston body.

Meanwhile, when fuel droplets adhere to the top face of the piston body thus reduced in a heat capacity, the piston temperature of the adhering portion decreases, so that the vaporization performance of the fuel deteriorates, which causes a decreased thermal efficiency. Furthermore, this leads to an increase in harmful components in exhaust gas such as soot particles (PM) and unburned hydrocarbon (HC) particularly at the time of cold start.

Therefore, in order to achieve both an improvement in thermal efficiency and a reduction in exhaust gas harmful components, the following technique is disclosed in JP 2013-67823 A (Patent literature 1). An anodic oxide layer having a low thermal conductivity and a low heat capacity is formed on the top face of a piston body, and a metal skin layer having a relatively higher heat capacity than that of the anodic oxide layer is disposed on the surface of a fuel injection region in the anodic oxide layer.

### CITATION LIST

### Patent Literature

PTL 1: JP 2013-67823 A

### SUMMARY OF INVENTION

### Technical Problem

In the meantime, as described also in Patent Literature 1, the anodic oxide layer having a low thermal conductivity and a low heat capacity is formed on the top face of the piston body, and the metal skin layer having a relatively higher heat capacity than that of the anodic oxide layer is disposed on the surface of the fuel injection region in the anodic oxide layer. This may cause an excessive increase in the temperature of the metal skin layer having a high heat capacity during the combustion of an air-fuel mixture, which causes the occurrence of abnormal combustion such as knocking or pre-ignition.

Therefore, a piston suppressing the abnormal combustion such as knocking and pre-ignition, and a cooling control method cooling the piston are required to be developed.

An object of the present invention is to provide a novel internal-combustion engine piston which makes it possible to achieve both an improvement in thermal efficiency and a reduction in exhaust gas harmful components, and to suppress the occurrence of abnormal combustion such as knocking and pre-ignition, and a method for controlling cooling of the piston.

### Solution to Problem

A first feature of the present invention lies in that a piston body includes a cooling passage formed therein; and a first heat shielding layer and a second heat shielding layer are formed on a top face of the piston body, wherein the first heat shielding layer is composed of a material having a lower thermal conductivity and volumetric specific heat than those of a piston base material, the second heat shielding layer is composed of a material having a lower thermal conductivity and volumetric specific heat than those of the first heat shielding layer, and a first separation distance between the first heat shielding layer and the cooling passage is set to be less than a second separation distance between the second heat shielding layer and the cooling passage.

According to a second aspect of the present invention lies in that cooling medium variable supply means for supplying a cooling medium into the cooling passage of the piston body, and changing a flow rate of the cooling medium is provided, wherein an amount of cooling medium supplied to the cooling passage is changed by the cooling medium variable supply means based on a cooling water temperature or a lubricating oil temperature of the internal-combustion engine.

### Advantageous Effects of Invention

According to the present invention, a cooling loss can be reduced by the second heat shielding layer, and the vaporization of fuel adhering to the top face of the piston body can be promoted by the first heat shielding layer to reduce exhaust gas harmful components. Since the first separation distance between the first heat shielding layer and the cooling passage is less than the second separation distance between the second heat shielding layer and the cooling passage, the first heat shielding layer is efficiently cooled by the cooling passage. Therefore, the temperature of the first heat shielding layer does not rise excessively, whereby the occurrence of abnormal combustion such as knocking and pre-ignition can be suppressed.

### BRIEF DESCRIPTION OF DRAWINGS

FIG. 1 is a cross-sectional view showing the cross section of an internal-combustion engine including a piston according to a first embodiment of the present invention.

FIG. 2 is an illustration diagram showing a mutual relationship between a thermal conductivity and volumetric specific heat of each of a base material constituting the piston shown in FIG. 1 and a heat shielding layer.

FIG. 3 is a top view of the piston shown in FIG. 1 as viewed from a cylinder head side.

FIG. 4 is an enlarged cross-sectional view of a part of the vicinity of a top face of the piston shown in FIG. 1.

FIG. 5 is an illustration diagram for illustrating an example of a method for controlling the opening degree of a cooling oil flow rate adjustment valve.

FIG. 6 is an illustration diagram for illustrating another example of a method for controlling the opening degree of a cooling oil flow rate adjustment valve.

FIG. 7 is an illustration diagram for illustrating still another example of a method for controlling the opening degree of a cooling oil flow rate adjustment valve.

FIG. 8 is an illustration diagram for illustrating the temperature change of the surface of a piston in one combustion cycle.

FIG. 9 is an illustration diagram for illustrating the temperature change of a first heat shielding layer of the piston shown in FIG. 4.

FIG. 10 is a top view for illustrating the area ratio of a first heat shielding layer to a second heat shielding layer of the piston shown in FIG. 3.

FIG. 11 is a cross-sectional view showing the cross section of an internal-combustion engine including a piston according to a second embodiment of the present invention.

FIG. 12 is a top view of the piston shown in FIG. 11 as viewed from a cylinder head side.

FIG. 13 is a cross-sectional view showing the cross section of an internal-combustion engine including a piston according to a second embodiment of the present invention.

FIG. 14 is an illustration diagram illustrating a positional relationship between an upper surface of the piston shown in FIG. 13 and a fuel injection valve, and showing a case where one first heat shielding layer is provided.

FIG. 15A is an illustration diagram illustrating a positional relationship between an upper surface of the piston shown in FIG. 13 and a fuel injection valve, and showing a case where a plurality of first heat shielding layers are provided.

FIG. 15B is a top view of a piston for illustrating a positional relationship between a fuel injection point of FIG. 15A and the first heat shielding layer.

FIG. 16 is a top view of the piston shown in FIG. 13 including a plurality of first heat shielding layers.

FIG. 17 is a sectional view schematically showing the structure of the surface layer of the piston.

FIG. 18 is an enlarged view schematically showing the structure of metal particles constituting the metal layer of FIG. 17.

### DESCRIPTION OF EMBODIMENTS

Hereinafter, the embodiment of the present invention will be described in detail with reference to the drawings, but the present invention is not limited to the following embodiments, and various modification examples and application examples are included within the technical concept of the present invention.

### Example 1

Hereinafter, a form of a piston according to a first embodiment of the present invention and an internal-combustion engine including the piston will be described with reference to the drawings.

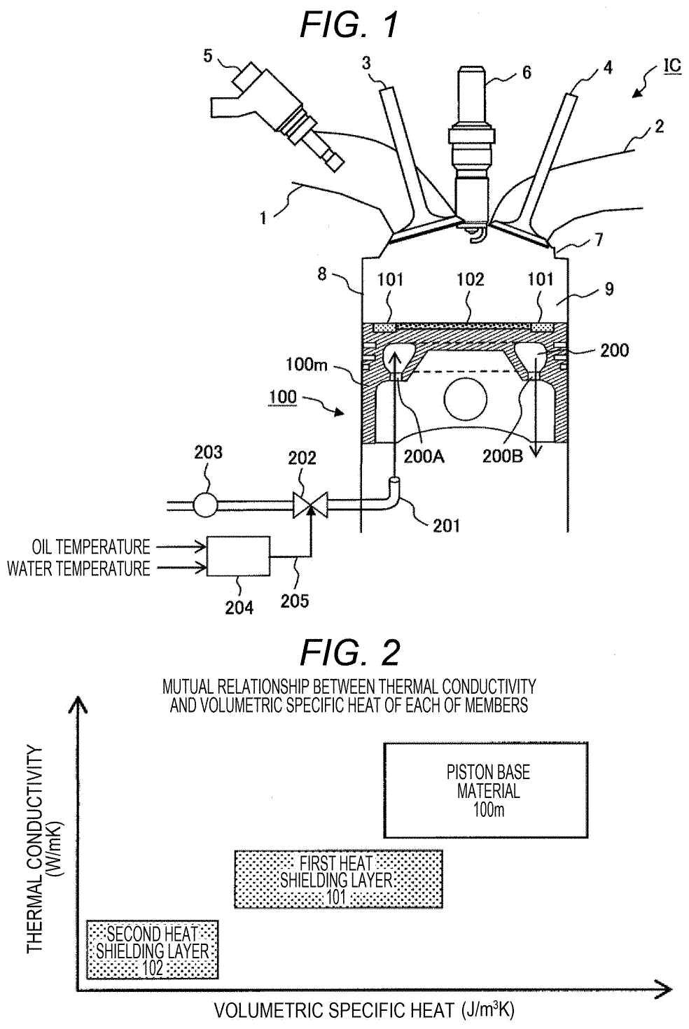

FIG. 1 shows a longitudinal cross section of the internal-combustion engine using the piston according to the first embodiment. An internal-combustion engine IC is a spark-ignited four-stroke internal-combustion engine. A combustion chamber 9 is formed by a cylinder head 7, a cylinder 8, a piston body 100, an intake valve 3, and an exhaust valve 4. The piston includes the piston body 100, a connecting rod for connecting the piston body 100 and a crankshaft to each other, and a piston ring and the like.

Also, a fuel injection valve 5 is provided in an intake port 1, and an injection nozzle thereof penetrates into the intake port. The fuel injection valve 5 constitutes a so-called port injection type internal-combustion engine. An exhaust port 2 for discharging combustion gas of the combustion chamber 9 is provided, and a spark plug 6 for igniting an air-fuel mixture is provided.

A first heat shielding layer 101 and a second heat shielding layer 102 are provided on a combustion chamber-side surface of a top face of the piston body 100 formed of a piston base material 100m. The first heat shielding layer 101 and the second heat shielding layer 102 form a part of the combustion chamber 9.

Here, in the comparison between the first heat shielding layer 101 and the second heat shielding layer 102, the first heat shielding layer 101 is composed of a thin plate material or a coating material and the like having “a low thermal conductivity and high volumetric specific heat”. The first heat shielding layer 101 desirably has a thermal conductivity of 1 to 10 W/mK, volumetric specific heat of 1000 kJ/m³K or more, and a thickness of 200 μm or more. The second heat shielding layer 102 is composed of a thin plate material or a coating material and the like having “a low thermal conductivity and low volumetric specific heat”. The second heat shielding layer 102 desirably has a heat conductivity of 0.5 W/mK or less, volumetric specific heat of 500 kJ/m³K or less, and a thickness of 50 to 200 μm.

Furthermore, the piston base material 100m is composed of an aluminum alloy, iron, or a titanium alloy and the like, and has a thermal conductivity of about 50 to 200 W/mK and volumetric specific heat of about 2000 to 3000 kJ/m³K. Therefore, the thermal conductivity has the relationship of piston base material>first heat shielding layer>second heat shielding layer, and the volumetric specific heat has the relationship of piston base material>first heat shielding layer>second heat shielding layer.

Here, the first heat shielding layer 101 having “a low thermal conductivity and high volumetric specific heat” has a function of hardly transmitting heat and easily retaining heat (greater heat capacity). The second heat shielding layer 102 having “a low thermal conductivity and low volumetric specific heat” has a function of hardly transmitting heat and having a quick heat response (small heat capacity). The reason why the thermal conductivity of the second heat shielding layer 102 is set to be less than the thermal conductivity of the first heat shielding layer 101 is that heat transfer from the second heat shielding layer 102 is reduced (heat shieldability is improved) to reduce a cooling loss. Specific materials and the like of the first heat shielding layer 101 and the first heat shielding layer 102 will be described later.

FIG. 2 shows an approximate mutual relationship between the thermal conductivity and volumetric specific heat of each of the piston base material 100m, the first heat shielding layer 101, and the second heat shielding layer 102 in the present Examples. In the present embodiment, as described above, the thermal conductivity and volumetric specific heat of the first heat shielding layer 101 are basically less than the thermal conductivity and volumetric specific heat of the piston base material 100m. However, the volumetric specific heats may overlap. The thermal conductivity and volumetric specific heat of the second heat shielding layer 102 are set to be less than the thermal conductivity and volumetric specific heat of the first heat shielding layer 101. Specific configuration examples of the first heat shielding layer 101 and the second heat shielding layer 102 will be described later.

Returning to FIG. 1, an annular cooling passage 200 is provided in the piston body 100. A part of a bottom face of the cooling passage 200 is opened, and a cooling oil is injected from a cooling oil jet nozzle 201 toward an opening part 200A of the cooling passage 200. The cooling oil that has entered into the cooling passage 200 is discharged from an opening part 200B provided on an opposite side. The cooling oil is pressurized by a cooling oil pump 203, and supplied to the cooling oil jet nozzle 201 via a cooling oil flow rate adjustment valve 202.

The flow rate of the cooling oil supplied to the cooling oil jet nozzle 201 is adjusted by a valve opening degree command value 205 of a controller 204 on the cooling oil flow rate adjustment valve 202. The controller 204 receives information such as a lubricating oil temperature and cooling water temperature of the engine detected by a temperature sensor (not shown). As described above, in the internal-combustion engine of the present Examples, the piston body 100 is cooled by using a so-called cooling channel.

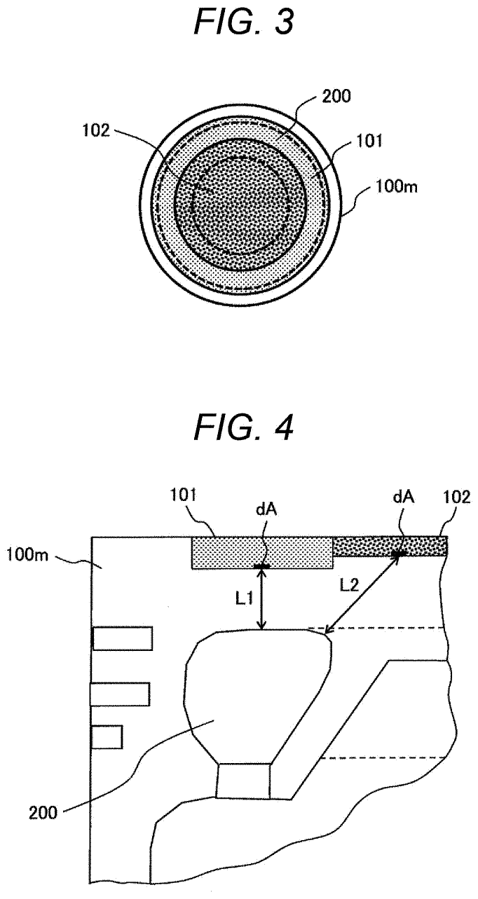

FIG. 3 shows the top face of the piston body 100 as viewed from a combustion chamber side in a sliding direction. The second heat shielding layer 102 having a substantially circular shape is disposed in the vicinity of the center of the surface of the piston base material 100m, and the first heat shielding layer 101 having an annular shape is disposed around the second heat shielding layer 102. The diameter of the second heat shielding layer 102 and the width (radial direction) of an annular part of the first heat shielding layer 101 are defined such that the area of the second heat shielding layer 102 is larger than that of the first heat shielding layer 101. The area ratio of the area of the second heat shielding layer 102 to the area of the first heat shielding layer 101 is set to a ratio of about 7:3, and the second heat shielding layer 102 has a larger area. This is because the cooling loss is further reduced.

FIG. 4 shows a part of the enlarged cross-section of the piston body 100. The minute area of the bottom face of each of the first heat shielding layer 101 and the second heat shielding layer 102 is defined as dA. A shortest separation distance between a contact surface of the first heat shielding layer 101 with the piston base material 100m and a surface of the cooling passage 200 is defined as L1. A shortest separation distance between a contact surface of the second heat shielding layer 102 with the piston base material 100m and a surface of the cooling passage 200 is defined as L2. Average separation distances Lm between the first heat shielding layer 101 and the cooling passage 200 and between the second heat shielding layer 102 and the cooling passage 200 are defined by the following equation.

$${L}_{m} = \frac{\int L d A}{\int d A} \qquad [ Equation 1 ]$$

In the present embodiment, the first heat shielding layer 101 is disposed on the top face of the piston body 100 in the vicinity of the cooling passage 200, so that the relationship between the average separation distance Lm1 between the first heat shielding layer 101 and the cooling passage 200 and the average separation distance Lm2 between the second heat shielding layer 102 and the cooling passage 200 satisfies Lm1<Lm2. In order to cause the average separation distance to satisfy Lm1<Lm2, for example, as shown in FIG. 3, the first heat shielding layer 101 is desirably disposed at a position where the first heat shielding layer 101 and at least a part of the cooling passage 200 overlap each other when viewed from the combustion chamber side in the sliding direction of the piston body 100.

In order to cause the average separation distance to satisfy Lm1<Lm2, for example, when the moving direction of the piston body 100 to the bottom dead point side is a lower side, at least a part of a lower surface of the first heat shielding layer 101 is desirably located below a lower surface of the second heat shielding layer 102.

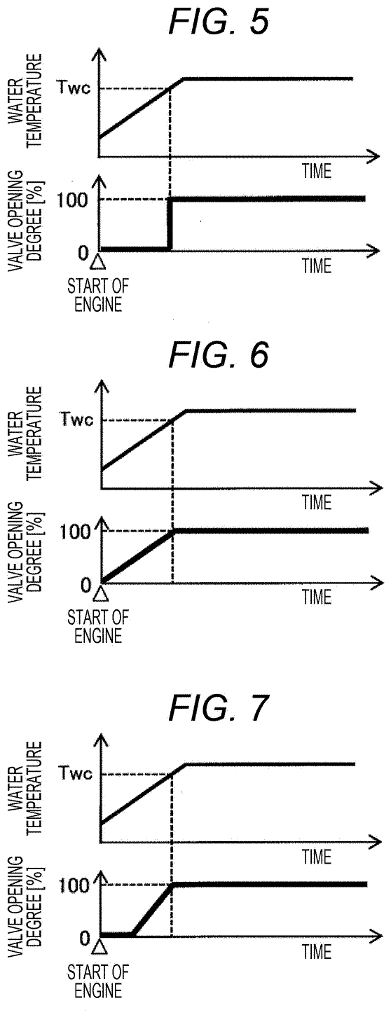

FIG. 5 shows an example of control of the controller 204 on a cooling oil flow rate control valve 202 after the cold start of the internal-combustion engine IC. When the cooling water temperature of the engine is lower than a predetermined water temperature Twc (for example, 80° C.), a valve body of the cooling oil flow rate control valve 202 is closed. When the cooling water temperature exceeds Twc, the valve body of the cooling oil flow rate control valve 202 is opened. As a result, the piston body 100 is cooled by cooling oil jet only when the water temperature is higher than Twc. It is needless to say that the same control may be performed based on the lubricating oil temperature in place of the cooling water temperature.

As shown in FIG. 6 and FIG. 7, the valve opening degree of the cooling oil flow rate control valve 202 may be continuously increased as the cooling water temperature or the lubricating oil temperature rises. In this case, as the cooling water temperature or the lubricating oil temperature rises, the cooling effect of the cooling oil jet on the piston body 100 is higher. As described above, if the valve opening degree of the cooling oil flow rate control valve 202 is continuously increased as the cooling water temperature or the lubricating oil temperature rises, the cooling of the cooling oil jet on the piston body 100 is finely controlled, whereby the reduction of the cooling loss can be maximized, and knocking and pre-ignition can be more effectively suppressed. The relationship between the cooling water temperature or the lubricating oil temperature and the valve opening degree is optional, and may be appropriately determined from the cooling characteristics and the like of the piston body 100.

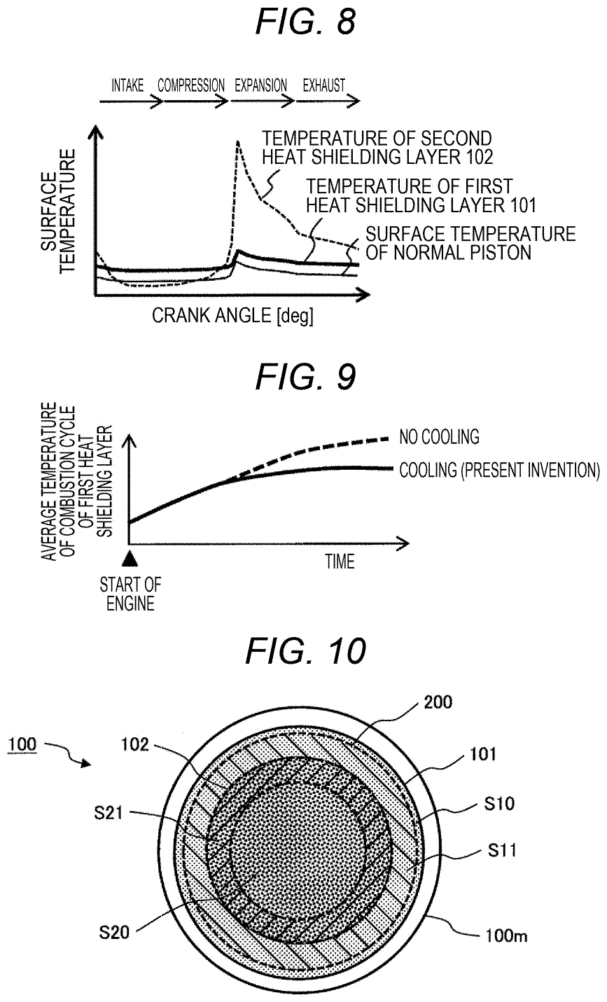

FIG. 8 shows the time change of the surface temperature of the top face of the piston body 100 when the internal-combustion engine IC including the piston according to the present embodiment is subjected to a combustion operation. More specifically, FIG. 8 shows the changes in the surface temperatures of the first heat shielding layer 101 and the second heat shielding layer 102 with respect to a crank angle in one combustion cycle including the intake, compression, expansion, and exhaust strokes of the internal-combustion engine. As reference, FIG. 8 also shows the surface temperature of a normal piston including only a conventional piston base material 100m in which the first heat shielding layer 101 and the second heat shielding layer 102 are not provided.

Since the second heat shielding layer 102 is composed of a material having “a low thermal conductivity and low volumetric specific heat”, its surface temperature follows a change in a combustion gas temperature in the combustion chamber with a small time delay and a small temperature difference. That is, in the middle stage of the intake stroke to the middle stage of the compression stroke, an in-cylinder gas temperature decreases due to the introduction of new air into the combustion chamber, whereby the surface temperature of the second heat shielding layer 102 accordingly decreases. Furthermore, in the later stage of the compression stroke to the exhaust stroke, the in-cylinder gas temperature rises due to the compression and combustion of the in-cylinder gas, whereby the surface temperature of the second heat shielding layer 102 accordingly rises.

As described above, in the second heat shielding layer 102, the surface temperature changes following the in-cylinder gas temperature, whereby the amount of heat transfer between the in-cylinder gas and the wall surface of the top face of the piston body 100 is reduced, which makes it possible to reduce the cooling loss of the engine. This is a so-called heat loss reduction method referred to as a temperature swing heat shielding method.

Meanwhile, since the first heat shielding layer 101 is composed of a material having “a low thermal conductivity and high volumetric specific heat”, its surface temperature is usually higher than the surface temperature of the piston, but it hardly follows a change in the in-cylinder gas temperature in a combustion cycle in the combustion chamber. For this reason, the change width of the surface temperature in one combustion cycle of the first heat shielding layer 101 is less than the change width of the surface temperature of the second heat shielding layer 102.

For example, while the change width of the surface temperature in the combustion cycle of the second heat shielding layer 102 is about 500° C., the change width of the surface temperature in the combustion cycle of the first heat shielding layer 101 is about 50° C. As a result, the surface temperature of the first heat shielding layer 101 tends to be higher than the surface temperature of the second heat shielding layer 102 and the surface temperature of the normal piston in the middle stage of the intake stroke to the middle stage of the compression stroke.

When the engine temperature is low, such as immediately after the cold start of the engine, the temperature of the air-fuel mixture near the wall surface of the combustion chamber including the top face of the piston body 100 is low, whereby the thickness of extinction in the vicinity of the wall surface increases, so that more unburned hydrocarbon is discharged. In the case where the engine temperature is low even when fuel droplets adhere to the wall surface, the evaporation thereof is slow, so that the discharge amount of unburned hydrocarbon increases. In particular, when only the second heat shielding layer 102 composed of the material having “a low thermal conductivity and low volumetric specific heat” is provided on the top face of the piston body 100 in order to reduce the cooling loss, the surface temperature is lower than the normal surface temperature in the intake stroke to the compression stroke, so that the discharge amount of unburned hydrocarbon at the time of cold further increases.

Meanwhile, when the first heat shielding layer 101 composed of the material having “a low thermal conductivity and high volumetric specific heat” is additionally provided, the temperature of the surface of the first heat shielding layer 101 in the intake stroke to the compression stroke is high, so that the heat causes a high temperature of in-cylinder gas containing unburned components in the vicinity of the surface of the first heat shielding layer 101. In the high temperature in-cylinder gas, the thickness of the extinction becomes thinner, and the vaporization of the droplets adhering to the surface of the first heat shielding layer 101 is promoted. These effects reduce the discharge amount of unburned hydrocarbon. Thus, both the first heat shielding layer 101 and the second heat shielding layer 102 are provided on the top face of the piston body 100, which makes it possible to reduce the exhaust gas harmful components at the time of cold, and to reduce the cooling loss to improve the fuel consumption of the engine.

Meanwhile, the first heat shielding layer 101 is composed of the material having “a low thermal conductivity and high volumetric specific heat”, so that the temperature of the first heat shielding layer 101 rises as the number of combustions increases to cause the temperature of the engine to rise. This causes an excessively high temperature of unburned gas in the vicinity of the surface of the first heat shielding layer 101, which may accordingly cause abnormal combustion such as knocking or pre-ignition.

In the present embodiment, a state causing abnormal combustion such as knocking or pre-ignition is estimated from the fact that the cooling water temperature or the lubricating oil temperature has reached a predetermined temperature. When the cooling water temperature or the lubricating oil temperature is higher than the predetermined temperature, the piston body 100 is cooled by the cooling oil jet. In the present embodiment, the separation distance between the cooling passage 200 of the piston body 100 and the first heat shielding layer 101 is less than the separation distance between the cooling passage 200 of the piston body 100 and the second heat shielding layer 102.

Generally, thermal resistance between two points in a solid is inversely proportional to a distance between the two points, whereby the cooling effect of the cooling passage 200 on the heat shielding layer is stronger as the separation distance between the cooling passage 200 and the heat shielding layer is smaller. Therefore, while the first heat shielding layer 101 is strongly cooled by the cooling passage 200, the cooling effect of the cooling passage 200 on the second heat shielding layer 102 is small.

FIG. 9 shows the time change of the average temperature of the combustion cycle of the first heat shielding layer 101 according to the present embodiment. In the present embodiment, the temperature of the first heat shielding layer 101 is kept low after the completion of warm-up, as a result of which the occurrence of abnormal combustion such as knocking or pre-ignition when the engine temperature rises can be suppressed. The second heat shielding layer 102 can suppress an increase in the cooling loss since the cooling effect of the cooling passage 200 is weak.

In the present embodiment, when the cooling water temperature or the lubricating oil temperature is lower than a predetermined temperature, the cooling of the cooling oil jet on the piston body 100 is stopped by the stop of the injection of the cooling oil or the decrease of the flow rate, or the cooling effect is weakly controlled, whereby the temperature of the first heat shielding layer 101 at the time of cold of the engine does not decrease, which can provide an improved reduction effect of the exhaust gas harmful components.

The temperature of the in-cylinder gas is generally highest at the center of the combustion chamber, and decreases toward the outer peripheral wall of the combustion chamber. Therefore, the second heat shielding layer 102 provided near the central part of the top face of the piston body provides a higher effect of reducing the cooling loss. Meanwhile, the temperature of the in-cylinder gas is low on the outer peripheral side of the combustion chamber, so that extinction or insufficient vaporization of the fuel is apt to occur. Therefore, the first heat shielding layer 101 is provided on the outer peripheral side of the combustion chamber, in other words, on the side of the region where the radius of the combustion chamber is large, and the temperature of the top face of the piston body on the outer peripheral side is risen, which provides a higher effect of reducing the exhaust gas harmful components.

The unburned gas on the outer peripheral side of the combustion chamber is compressed for self-ignition causes knocking, so that it is effective to cool the outer peripheral side of the combustion chamber in order to prevent the knocking. For this reason, the cooling passage 200 and the first heat shielding layer 101 are desirably disposed in a circular shape or an arc shape near the outer peripheral side of the piston body 100.

In the present embodiment, the relationship between the average separation distance Lm1 between the first heat shielding layer 101 and the cooling passage 200 and the average separation distance Lm2 between the second heat shielding layer 102 and the cooling passage 200 satisfies Lm1<Lm2. However, the overlapping ratio between the first heat shielding layer 101 and the cooling passage 200 may be greater than the overlapping ratio between the second heat shielding layer 102 and the cooling passage 200.

More specifically, as shown in FIG. 10, when the piston body 100 is projected from the combustion chamber side in the sliding direction, the projected area of the first heat shielding layer 101 is taken as “S₁₀”; the projected area of the second heat shielding layer 102 is taken as “S₂₀”; the projected area of a portion where the first heat shielding layer 101 and the cooling passage 200 overlap is taken as “S₁₁”; and the projected area of a portion where the second heat shielding layer 102 and the cooling passage 200 overlap is taken as “S₂₁”.

When the overlapping ratio between the first heat shielding layer 101 and the cooling passage 200 is taken as “S₁₁/S₁₀” and the overlapping ratio between the second heat shielding layer 102 and the cooling passage 200 is taken as “S₂₁/S₂₀”, it is effective to satisfy the following equation.

$$\frac{{S}_{11}}{{S}_{10}} > \frac{{S}_{21}}{{S}_{20}} \qquad [ Equation 2 ]$$

Therefore, it is necessary to define the arrangements and sizes of the first heat shielding layer 101, the second heat shielding layer 102, and the cooling passage 200 such that the overlapping ratio of the first heat shielding layer 101 is greater than the overlapping ratio of the second heat shielding layer 102. As described above, when the overlapping ratio between the heat shielding layer and the cooling passage is great, the cooling effect of the cooling passage is improved. Therefore, when the overlapping ratio of the first heat shielding layer 101 is greater than the overlapping ratio of the second heat shielding layer 102, the first heat shielding layer 101 is more strongly cooled by the cooling passage 200 than the second heat shielding layer 102 is.

As described above, according to the present embodiment, by the second heat shielding layer having “a low thermal conductivity and low volumetric specific heat”, the cooling loss is reduced, and by the first heat shielding layer having “a low thermal conductivity and high volumetric specific heat”, the vaporization of the fuel adhering to the piston body can be promoted to reduce the exhaust gas harmful components. The first separation distance between the first heat shielding layer and the cooling passage is less than the second separation distance between the second heat shielding layer and the cooling passage, whereby the first heat shielding layer is efficiently cooled by the cooling passage, to prevent the temperature of the first heat shielding layer from excessively rising, which makes it possible to suppress the occurrence of abnormal combustion such as knocking or pre-ignition. Furthermore, the cooling of the cooling passage on the second heat shielding layer can be suppressed to prevent the increase in the cooling loss.

### Example 2

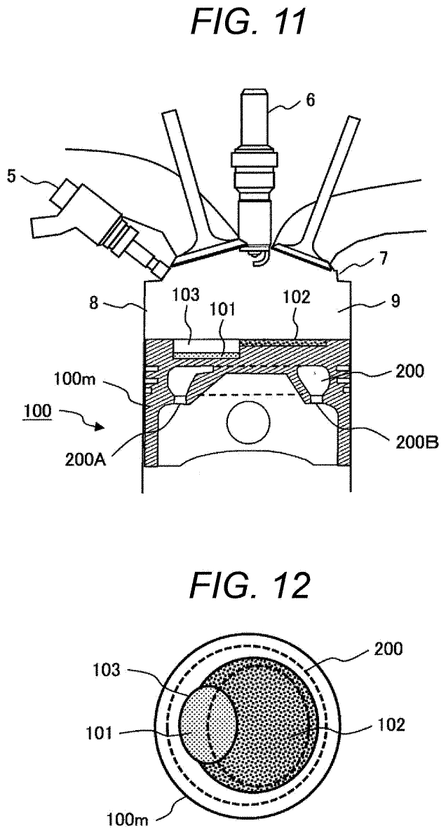

Next, a second embodiment of the present invention will be described with reference to FIG. 11 and FIG. 12. FIG. 11 shows a cross section of an essential part of an internal-combustion engine in the present embodiment. FIG. 12 shows an upper surface of a piston body of the present embodiment as viewed from a combustion chamber side. The internal-combustion engine in the present embodiment is a so-called in-cylinder direct injection internal-combustion engine in which a fuel injection valve 5 is provided in an engine head 7, and an injection nozzle thereof is directed to a combustion chamber 9 to inject fuel so as to penetrate through the combustion chamber.

Furthermore, in the top face of the piston body 100, a cavity 103 recessed toward a bottom dead point side is provided. A first heat shielding layer 101 is provided on the bottom part of the cavity 103, and a second heat shielding layer 102 is provided on the top face of the piston body 100 outside the cavity 103. When viewed from the combustion chamber side in the sliding direction of the piston body 100, the cavity 103 and a cooling passage 200 are disposed such that the cavity 103 and at least a part of the cooling passage 200 overlap.

When the temperature of an engine is low such as immediately after at the time of cold start of the engine, fuel is injected from the fuel injection valve 5 toward the cavity 103 in the late stage of a compression stroke, whereby an air-fuel mixture having a high fuel concentration is formed in the vicinity of an electrode part of a spark plug 6. This provides improved ignitability of the air-fuel mixture, whereby stable combustion is performed even when an ignition timing is retarded as compared with that during a normal operation, which provides efficient temperature rising of an exhaust gas purification catalyst (not shown) by high temperature exhaust gas associated with the ignition retardation. Furthermore, at the time of cold, the temperature of the first heat shielding layer 101 provided on the bottom face of the cavity 103 rises, whereby a fuel liquid layer formed on the bottom face of the cavity 103 is vaporized in a short time, which suppresses the discharge of unburned hydrocarbon and soot.

When viewed from the combustion chamber side in the sliding direction of the piston body 100, the cavity 103 and the cooling passage 200 are disposed such that the cavity 103 and at least a part of the cooling passage 200 overlap, whereby the first heat shielding layer 101 provided on the bottom face of the cavity 103 is efficiently cooled by the cooling passage 200 after the warm-up of the engine to suppress the occurrence of abnormal combustion such as knocking or pre-ignition.

In order to more efficiently cool the first heat shielding layer 101 provided on the bottom face of the cavity 103 and to reduce a cooling loss from the second heat shielding layer 102, it is effective to make the width of the cooling passage 200 on the side of the cavity 103 greater than the width of the cooling passage 200 in other portion to increase a heat transfer area between the cavity 103 and the cooling passage 200.

It is desirable to provide an opening part (inlet side) 200A for taking in a cooling oil for cooling the piston body on the side of the cavity 103, and to dispose an opening part (outlet side) 200B for discharging the cooling oil on the opposite side of the cavity 103. In this case, the side of the cavity 103 is the side of an inlet, which provides a low cooling oil temperature, and the opposite side of the cavity 103 is the side of an outlet, which provides a high cooling oil temperature. Therefore, the first heat shielding layer 101 provided on the bottom face of the cavity 103 is efficiently cooled, and the cooling of the second heat shielding layer 102 is suppressed.

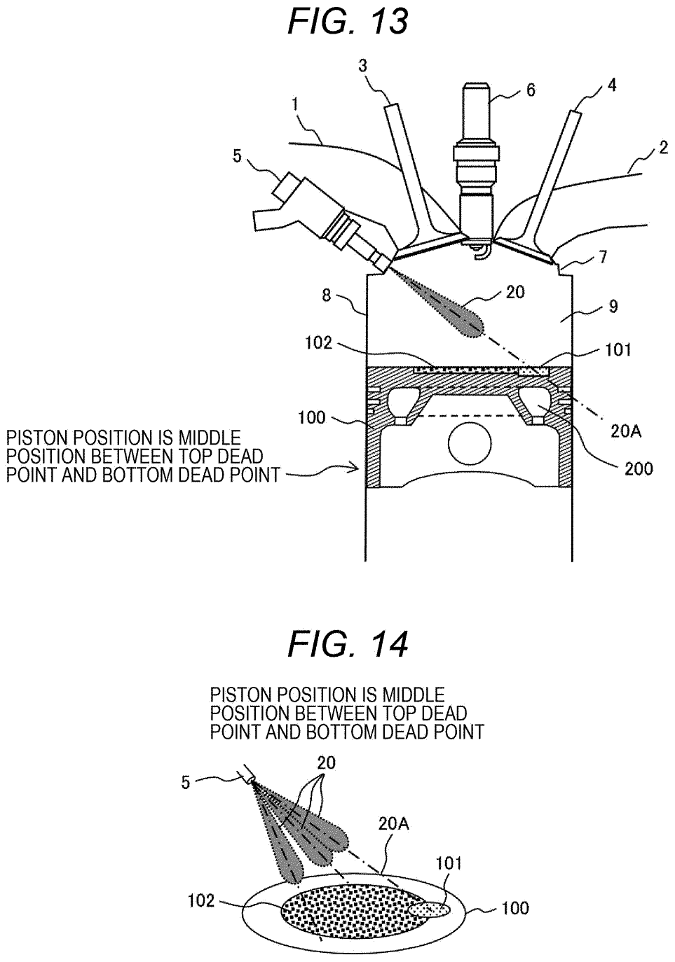

In the piston applied to the in-cylinder direct injection internal-combustion engine, the first heat shielding layer 101 is locally provided on the top face of the piston body 100 on which the fuel liquid layer is formed, whereby the vaporization of the injected fuel can be efficiently promoted, and the area of the second heat shielding layer 102 can be maximized to reduce the cooling loss. For this purpose, as shown in FIG. 13, when the position of the piston reaches a position near the middle between the top dead point and the bottom dead point, it is effective to provide the first heat shielding layer 101 at a position where an extension axis (center line) 20A of the center of gravity of fuel spray 20 injected from the fuel injection valve 5 intersects with the top face of the piston body 100.

Furthermore, it is desirable to define the positions of the cooling passage 200 and first heat shielding layer 101, and the direction of the fuel spray 20 such that an average distance Lm1 between the first heat shielding layer 101 and the cooling passage 200 is less than an average distance Lm2 between the second heat shielding layer 102 and the cooling passage 200. By setting the overlapping ratio between the first heat shielding layer 101 and the cooling passage 200 to be greater than the overlapping ratio between the second heat shielding layer 102 and the cooling passage 200, the first heat shielding layer 101 after warm-up can be efficiently cooled.

When the fuel injection valve 5 is constituted by a porous nozzle, and a plurality of fuel sprays are formed, as shown in FIG. 14, the first heat shielding layer 101 is provided at a position where the axis 20A of at least one of the sprays intersects with the piston, whereby the vaporization promotion effect of the first heat shielding layer 101 on the fuel liquid layer is obtained.

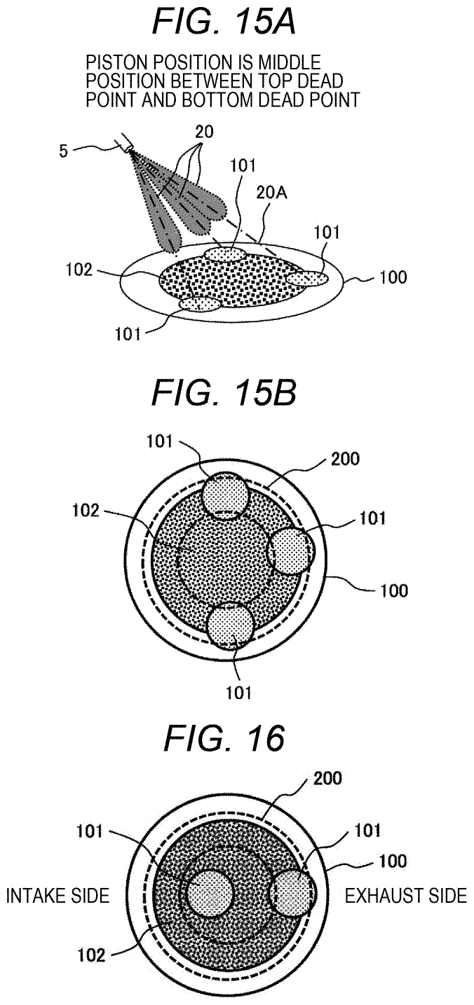

As shown in FIGS. 15A and 15B, the plurality of first heat shielding layers 101 are provided so as to correspond to the extension axes 20A of the plurality of sprays at positions where the extension axes 20A intersect with the top face of the piston body 100, whereby the vaporization promotion effect of the first heat shielding layer 101 on the fuel liquid layer can be further improved.

Furthermore, when the plurality of first heat shielding layers 101 are provided, as shown in FIG. 16, the average distance between at least one of the first heat shielding layers 101 and the cooling passage 200 may be less than the average distance between the second heat shielding layer 102 and the cooling passage 200. The overlapping rate between at least one of the first heat shielding layers 101 and the cooling passage 200 may be greater than the overlapping rate between the second heat shielding layer 102 and the cooling passage 200.

As described above, when at least one of the first heat shielding layers 101 is the first heat shielding layer 101 disposed on the exhaust side of the combustion chamber, the exhaust-side first heat shielding layer 101 having a higher temperature is close to the cooling passage 200, whereby the first heat shielding layer 101 is strongly cooled, which is more effective in suppressing abnormal combustion such as knocking and pre-ignition.

Furthermore, in order to reduce fuel consumption and CO2 in recent years, so-called idling stop control is widely adopted, in which the operation of the engine is stopped when the vehicle is temporarily stopped. During idling stop, the first heat shielding layer 101 having great volumetric specific heat is maintained at a high temperature. For this reason, air in the vicinity of the surface of the first heat shielding layer 101 is heated, which causes pre-ignition when the engine is restarted. In order to prevent the pre-ignition, it is effective to supply a cooling oil from a cooling oil jet nozzle into the cooling passage 200 of the piston body during idling stop to cool the first heat shielding layer 101. In this case, the cooling oil may be supplied by an electric pump.

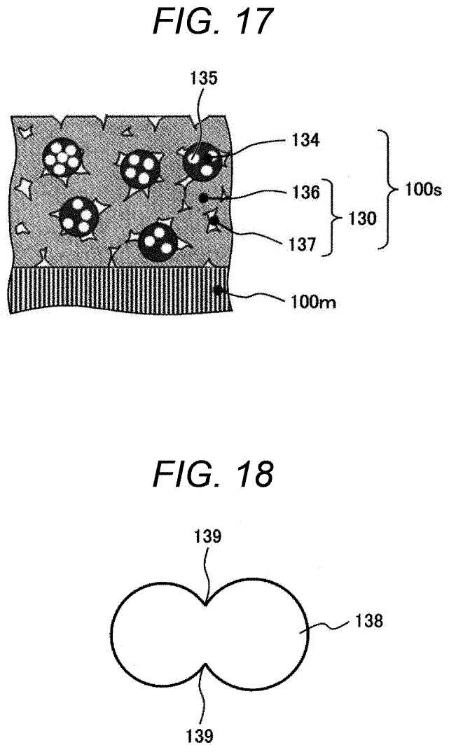

Next, the configurations of the first and second heat shielding layers 101 and 102 described above will be described in detail with reference to FIGS. 17 and 18.

Hereinafter, both the first heat shielding layer 101 and the second heat shielding layer 102 will be described as a surface layer. FIG. 17 is a cross section schematically showing the surface layer. A surface layer 100s includes a matrix 130 and hollow particles 134 dispersed in the matrix 130. The hollow particles 134 have a hole 135 therein. The matrix 130 includes a metal layer 136 constituted by bonding a plurality of metal particles, and a void 137 surrounded by a portion other than a bonding portion of the metal particles (in other words, a void formed between the metal particles). The hollow particles 134 are contained in the void 137.

A ratio of a volume occupied by the void 137 contained in the matrix 130 and the hole 135 contained in the hollow particles 134 in the surface layer 100s is referred to as “a porosity”. By increasing the porosity, the thermal conductivity and volumetric specific heat of the surface layer 100s can be reduced. Therefore, the porosity of the first heat shielding layer 101 is set to be less than that of the second heat shielding layer 102 in order to increase the thermal conductivity and volumetric specific heat of the first heat shielding layer 101 as compared to those of the second heat shielding layer 102. When the surface layer 100s constitutes the first heat shielding layer 101, the porosity is set to, for example, about 20% in order to provide a low thermal conductivity and high volumetric specific heat. Meanwhile, when the surface layer 100s constitutes the second heat shielding layer 102, the porosity is set to, for example, about 50% in order to provide a low thermal conductivity and low volumetric specific heat.

In order that the surface layer 100s withstands a severe environment (high temperature, high pressure, strong vibration) in the internal-combustion engine, high adhesion to a base material 100m and high tensile strength are required for the surface layer 100s. By using the matrix 130 constituting the main portion of the porous surface layer 100s as the metal layer 136, high adhesion and high durability between the metal base material 100m and the surface layer 100s can be obtained.

The hollow particles 134 are contained in the void 137 of the matrix 130, and the void 137 in the matrix 130 is combined with the hole 135 of the hollow particles 134, whereby the volume amount of the void 137 in the matrix 130 is suppressed while the porosity required for lowering the thermal conductivity is secured, which allows the strength of the surface layer 100s to be highly kept.

The metal layer 136 is preferably composed of a sintered metal in which metal particles are bonded by sintering. FIG. 18 shows an enlarged view of metal particles constituting a metal layer 130 of FIG. 17. As shown in FIG. 18, it is preferable that metal particles 138 are partially bonded by sintering to provide necks 139. A space between the metal particles can be secured by the necks 139, to form the void 137. By controlling a sintering density, the ratio of the void 137 can be controlled, to variously change the thermal conductivity, volumetric specific heat, and strength of the surface layer 100s.

It is preferable that the metal layer 136 and the base material 100m contain the same metal as a main component thereof. Specifically, it is preferable that the base material 100m is composed of an aluminum (Al) alloy and the metal layer 136 is composed of aluminum (Al). As described above, the base material 100m and the metal layer 136 constituting the main portion of the surface layer 130 are composed of the same metal, whereby a robust solid phase bonding part is formed at the interface between the base material 100m and the surface layer 100s having a porous structure to secure high adhesion, which can achieve the surface layer 100s having excellent durability.

The material of the hollow particles 134 preferably has a small thermal conductivity and high strength even if it is hollow in order to secure the heat insulation performance of the surface layer 130. Examples of the material include silica, alumina, and zirconia. Examples of the hollow particles containing silica as a main component include ceramic beads, silica aerogel, and porous glass.

As described above, according to the present invention, the cooling passage is formed in the piston body; the first heat shielding layer composed of a material having a lower thermal conductivity and volumetric specific heat than those of the piston base material, and the second heat shielding layer composed of a material having a lower thermal conductivity and volumetric specific heat than those of the first heat shielding layer are provided on the top face of the piston body; and the first separation distance between the first heat shielding layer and the cooling passage is set to be less than the second separation distance between the second heat shielding layer 102 and the cooling passage 200. Variable cooling medium supply means for supplying a cooling medium into the cooling passage of the piston body and changing the flow rate of the cooling medium is provided, to cause the variable cooling medium supply means to change the supply amount of cooling medium to the cooling passage based on the cooling water temperature or lubricating oil temperature of the internal-combustion engine.

Therefore, the second heat shielding layer reduces the cooling loss, and the first heat shielding layer promotes the vaporization of the fuel adhering to the piston body, whereby the exhaust gas harmful components can be reduced. The first separation distance between the first heat shielding layer and the cooling passage is less than the second separation distance between the second heat shielding layer and the cooling passage, whereby the first heat shielding layer is efficiently cooled by the cooling passage, to prevent the temperature of the first heat shielding layer from rise excessively. This can suppress the occurrence of abnormal combustion such as knocking or pre-ignition.

The present invention is not limited to the above-described Examples, and various modifications are included therein. For example, the above-described Examples are described in detail for convenience of explanation and good understanding of the present invention, and thus the present invention is not limited to one having all the described configurations. Additionally, it is possible to replace a part of the configuration of certain Example with the configuration of another Example, and it is also possible to add the configuration of certain Example to the configuration of another Example. Further, regarding a part of the configuration of each Example, addition of another configuration, its deletion, and replacement with another configuration can be performed.

### REFERENCE SIGNS LIST

5 fuel injection valve
6 spark plug
20 fuel spray
20A axis of fuel spray
100 piston body
100m piston base material
100s surface layer
101 first heat shielding layer
102 second heat shielding layer
103 cavity
200 cooling passage
201 cooling oil jet
130 matrix
134 hollow particles
135 hole
136 metal layer
137 void
138 metal particles
139 neck

1. An internal-combustion engine piston comprising: a piston body including a cooling passage formed in the piston body; and a first heat shielding layer and a second heat shielding layer formed on a top face of the piston body and forming a part of a combustion chamber, wherein
the first heat shielding layer is composed of a material having a lower thermal conductivity and volumetric specific heat equal to or lower than those of a piston base material forming the piston body,
the second heat shielding layer is composed of a material having a lower thermal conductivity and volumetric specific heat than those of the first heat shielding layer, and
a separation distance between the first heat shielding layer and the cooling passage is set to be less than a separation distance between the second heat shielding layer and the cooling passage.

2. The internal-combustion engine piston according to claim 1, wherein the first heat shielding layer is formed at a position where the first heat shielding layer overlaps at least a part of the cooling passage when viewed from a side of the combustion chamber in a sliding direction of the piston body.

3. The internal-combustion engine piston according to claim 2, wherein a ratio of an overlapping projected area of the first heat shielding layer and the cooling passage to a projected area of the first heat shielding layer is set to be greater than a ratio of an overlapping projected area of the second heat shielding layer and the cooling passage to a projected area of the second heat shielding layer when viewed from the side of the combustion chamber in the sliding direction of the piston body.

4. The internal-combustion engine piston according to claim 1, wherein at least a part of a lower surface of the first heat shielding layer is positioned lower than a lower surface of the second heat shielding layer when a direction of movement of the piston body to a bottom dead point is a lower side.

5. The internal-combustion engine piston according to claim 1, wherein the first heat shielding layer is disposed on a region having a greater combustion chamber radius than that of a region in which the second heat shielding layer is disposed.

6. The internal-combustion engine piston according to claim 1, wherein the first heat shielding layer and the cooling passage are formed in a circular shape or an arc shape, and disposed in the piston body.

7. The internal-combustion engine piston according to claim 1, wherein the cooling passage is formed closer to an exhaust side than a vicinity of a center of the combustion chamber.

8. The internal-combustion engine piston according to claim 1, wherein
a cavity is formed in the top face of the piston body, and
the first heat shielding layer is provided on at least a bottom face of the cavity.

9. The internal-combustion engine piston according to claim 8, wherein the cavity and at least a part of the cooling passage overlap when viewed from the side of the combustion chamber in the sliding direction of the piston body, and a width of the cooling passage on a side of the cavity is greater than that of the cooling passage on a side facing the cavity.

10. The internal-combustion engine piston according to claim 8, wherein a cooling oil inlet of the cooling passage is formed on a side of the cavity, and a cooling oil outlet of the cooling passage is formed on an opposite side of the cavity.

11. The internal-combustion engine piston according to claim 1, wherein the piston body is used in an in-cylinder direct injection internal-combustion engine including a fuel injection valve for directly injecting fuel into the combustion chamber.

12. The internal-combustion engine piston according to claim 11, wherein the first heat shielding layer is formed at a position where the first heat shielding layer intersects with at least one of axes of spray injected from the fuel injection valve when the piston body is in a vicinity of an intermediate position between a top dead point and a bottom dead point.

13. An internal-combustion engine piston comprising: a piston body including a cooling passage formed in the piston body; and a first heat shielding layer and a second heat shielding layer formed on a top face of the piston body and forming a part of a combustion chamber, wherein
the first heat shielding layer is composed of a material having a lower thermal conductivity and volumetric specific heat equal to or lower than those of a piston base material forming the piston body,
the second heat shielding layer is composed of a material having a lower thermal conductivity and volumetric specific heat than those of the first heat shielding layer, and
the first heat shielding layer is disposed closer to an intake side and an exhaust side than a vicinity of a center of the combustion chamber, and a separation distance between the first heat shielding layer and the cooling passage disposed on the exhaust side is set to be less than a separation distance between the second heat shielding layer and the cooling passage.

14. The internal-combustion engine piston according to claim 1, wherein the first heat shielding layer and the second heat shielding layer are formed of a porous body, and a porosity of the first heat shielding layer is set to be less than that of the second heat shielding layer.

15. The internal-combustion engine piston according to claim 1, wherein a thickness of the first heat shielding layer is set to be greater than that of the second heat shielding layer.

16. The internal-combustion engine piston according to claim 1, wherein a total area of the first heat shielding layer forming the combustion chamber is set to be less than a total area of the second heat shielding layer forming the combustion chamber.

17. A method for controlling cooling of an internal-combustion engine piston, the internal-combustion engine including the internal-combustion engine piston according to claim 1, cooling medium supply means for supplying a cooling medium into the cooling passage, and cooling medium variable supply means for changing a flow rate of the cooling medium,
wherein an amount of cooling medium supplied from the cooling medium supply means to the cooling passage is adjusted by the cooling medium variable supply means based on a cooling water temperature or a lubricating oil temperature of the internal-combustion engine.

18. The method for controlling cooling of an internal-combustion engine piston according to claim 17, wherein the amount of cooling medium supplied to the cooling passage in a case where the cooling water temperature or the lubricating oil temperature is high is increased as compared to a case where the cooling water temperature or the lubricating oil temperature is low.

19. The method for controlling cooling of an internal-combustion engine piston according to claim 17, wherein, when the cooling water temperature or the lubricating oil temperature is lower than a predetermined temperature, supply of the cooling medium to the cooling passage is stopped, and when the cooling water temperature or the lubricating oil temperature is higher than the predetermined temperature, the cooling medium is supplied to the cooling passage.

20. A method for controlling cooling of an internal-combustion engine piston,
the internal-combustion engine including the internal-combustion engine piston according to claim 1, cooling medium supply means for supplying a cooling medium into the cooling passage, and cooling medium variable supply means for changing a flow rate of the cooling medium, wherein
the cooling medium is supplied from the cooling medium supply means to the cooling passage during an idling stop period of the internal-combustion engine.
